(19) United States
(12) Patent Application Publication
(10) Pub. No.: US 2023/0235720 A1
(43) Pub. Date: Jul. 27, 2023

(54) VEHICLE ENGINE HEATER

(71) Applicant: Leslie P Duke, Lindale, GA (US)

(72) Inventor: Leslie P Duke, Lindale, GA (US)

(21) Appl. No.: 17/580,740

(22) Filed: Jan. 21, 2022

(51) Int. Cl. F02N 19/02

(52) U.S. Cl. CPC F02N 19/02

(57) ABSTRACT

A vehicle engine heater includes a heat generator or heater portion and a heat distribution portion. The heater portion includes an external housing defining an interior air channel therethrough extending from an intake port to an exhaust port. An electric fan and heating elements are mounted within the air channel. The electric fan and heating elements are coupled to an electric power cord having a controller to control the electricity flowing to the electric fan and heating elements. The heat distribution portion includes an elongated main conduit and a base having a pair of legs includes two laterally opposed feet. The main conduit has a series of air openings extending from the central channel to a top surface. The open end is coupled to the housing of the heater portion at the location of the exhaust port.

### CROSS REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### FIELD OF THE INVENTION

The present inventive concept relates to the field of engine heaters. More particularly, the invention relates to a heater for an engine of a vehicle.

### TECHNOLOGY IN THE FIELD OF THE INVENTION

Vehicles such as cars, trucks, boats, motorcycles, snowmobiles and the like have internal combustion engines. Typically, a person merely starts the engine when the vehicle is to be driven. However, in very cold weather the engine may be difficult to start due the cold temperature of the engine and the fuel. Furthermore, as these internal combustion engines utilize oil to lubricate the internal parts of the engine, the cold weather could cause the oil to become less viscous, creating a problem in passing the oil through the engine, which could result in causing damage to the engine or reducing the engine's efficiency.

In the past, some vehicles, such as cars, have included an electric heater that is placed within the engine bay of the car. These electric heaters have an electrically resistive coil that heats during use, thereby warming the air surrounding the electric heater. If the electric heater is in the form of a blanket covering the engine, the electric heater must be removed prior to operating the engine, which can be tedious and time consuming.

Some vehicle engine heaters are electrically resistive coils within a pad that is mounted to the oil reservoir of the engine. While these pads may warm the lower portion of the engine and the oil within the engine oil reservoir, they do not heat the other portions of the engine.

Lastly, some vehicle engine heaters are simple electrically resistive air heaters placed within the engine bay. These engine heaters typically heat the area directly in front of the heater exhaust.

Accordingly, a need exists for an engine heater that may heat an entire area of an engine or engine bay. It is to the provision of such therefore that the present invention is primarily directed.

### BRIEF SUMMARY OF THE INVENTION

A vehicle engine heater comprising a heater portion to generate a warm airstream, and a heat distribution portion coupled to the heater portion to distribute the warm airstream from the heater portion. The heat distribution portion includes an elongated conduit and a base coupled to the elongated conduit. The elongated conduit having a series of air openings through which the warm airstream may pass.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a perspective view of a vehicle engine heater embodying principles of the invention in a preferred form.

FIG. 2 is a cross-sectional view of a portion of the vehicle engine heater of FIG. 1.

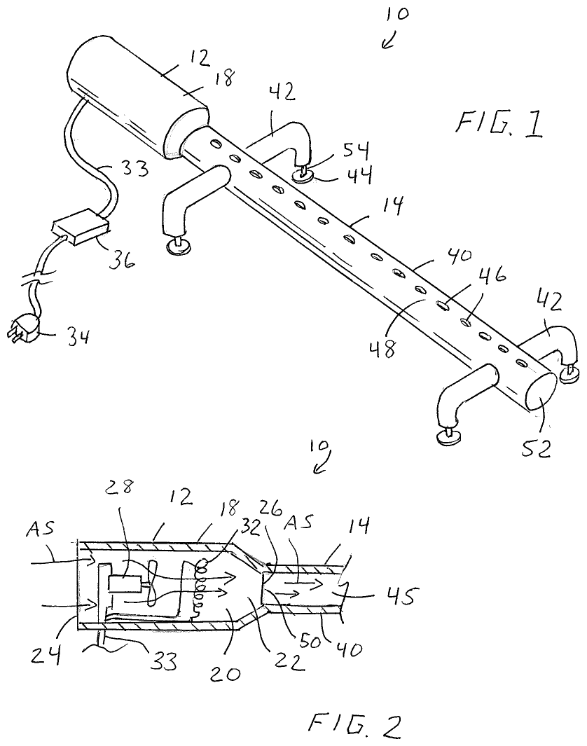

### DETAILED DESCRIPTION OF CERTAIN EMBODIMENTS

### Definitions

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

### Description of Selected Specific Embodiments

With reference next to the drawings, there is a shown a vehicle engine heater 10 in a preferred form of the present invention. The vehicle engine heater 10 includes a heat generator or heater portion 12 and a heat distribution portion 14.

The heater portion 12 includes an external housing or casing 18 defining an interior space 20 with an air channel 22 therethrough extending from an air entrance or intake port 24 to an air exit or exhaust port 26. An electric fan 28 is mounted within the channel 22. Electrically resistive heating elements 32 are also positioned within the air channel 22. The electric fan 28 creates an airstream AS that enters the air channel 22 through air intake port 24, passes through electric fan 28, over the heating elements 32, and exists that air channel 22 through exhaust port 26. The housing 18 may be made of a heat resistive plastic, metal or the like.

The electric fan 28 and heating elements 32 are coupled to an electric power cord 33 terminating at a conventional electric plug 34. A controller 36 is also coupled to the power cord 33 so as to control the electricity flowing to the electric fan 28 and heating elements 32. The controller 36 may be configured to vary the current passing to the electric fan 28 to vary the speed of the electric fan 28. The controller 36 may also include electronics that periodically or cyclically turn the electric fan 28 and heating elements 32 on and off so that they are not continuously operating, i.e., they are operated through a timing program or a temperature program that takes input from a controller temperature sensor to determine when and for how long the heater 10 should operate to heat the vehicle engine.

The heat distribution portion 14 includes an elongated main conduit, pipe, tube, or housing 40 and a conduit base 42. The base 42 may be in the form of a pair of legs 42 wherein each pair of legs 42 includes two laterally opposed feet 44. The main conduit 40 has a central channel 45 and a plurality or series of air openings 46 extending from the central channel 45 to a top surface 48 of the main conduit 40. The main conduit 40 has a first, open end 50 in fluid communication with the central channel 45 and exhaust port 26, and a second, closed end 52 oppositely disposed from the open end 50. The open end 50 is coupled to the housing 18 of the heater portion 12 at the location of the exhaust port 26. The heat distribution portion 14, or at least the main conduit 40, is made of a heat resistive plastic, metal or the like. The heat distribution portion 14 may be separate from (two pieces) or integral (one piece) with the heater portion 12.

In use, the vehicle engine heater 10 is placed upon the ground in a position to be under the engine of the vehicle, i.e., the vehicle engine heater 10 is place on a supporting surface such as a garage floor, driveway, or street. The vehicle engine heater 10 may be placed below the car or may be place on the ground and the car then driven to a position over the vehicle engine heater 10. The overall height of the vehicle engine heater 10 allows for clearance of the car while being close enough to direct warm air into the engine bay of the vehicle.

The vehicle engine heater 10 is then coupled to a municipal electricity source through electric plug 34 and turned on through actuation of the controller 36. The controller 36 controls the flow of electric current passing through power cord 33 to the electric fan 28 and heating elements 33. The heating elements 33 become hot as the electric fan 28 creates an airstream AS that is warmed as it passes through the air channel 22 by entering the heater portion 12 through intake port 24, over the heating elements 33, and out of the exhaust port 26.

The airstream AS enters the heat distribution portion 14 through the open end 50 of the conduit 40. The airstream AS then exits the conduit 40 in an upward direction through the plurality of air openings 46 along the top surface 48 of the conduit 40, thereby distributing the warm air along an extended length of the conduit 40 and into the overlying entire engine bay of the vehicle.

The controller 36 may cycle the operation of the vehicle engine heater 10 so that the heat is intermittent and not constant. Also, the controller 36 may control the fan speed of the blower and/or heating temperature of the heating elements.

The distribution of air along an extended length of the conduit 40 prevents a concentration of hot air that may cause damage to certain components of the engine, transmission or other mechanisms within the engine bay. This distribution also allows for a better warm air distribution throughout the entire engine bay, rather than being concentrated in a select area adjacent a heater.

It should be understood that one, thin elongated slot may be the equivalent structure as a plurality of smaller holes.

The vehicle engine heater 10 may also be designed to be coupled for operational use to the vehicles d.c. battery, so that it may be used in more remote locations or without a municipal power supply.

The vehicle engine heater 10 may also be used in conjunction with other types of vehicles such as a car, boat or motorcycle. The use of a cover also aids in trapping or maintaining the warm air in the proper area, this is especially true when used with motorcycles that do not have a defined engine bay to partially entrap the heated air.

Also, the main conduit 40 may be flexible to enable shaping it to the size of engine bay.

The legs 42 or feet 44 may be incorporated into the shape of the main conduit 40, for example, the conduit 40 may have a triangular cross-sectional shape with wide bottom surface area and narrow top. The wide bottom surface would be considered to be the base, foot or legs of the main conduit. Also, the base or legs 42 may be coupled to the conduit 40 by mounting the base or legs directly to the heater portion 12, or they may be removable so that the heater does not include feet or legs.

It should be understood that the legs 42 may be made to be adjustable so as to place the conduit 40 at different heights above the ground and closer or farther from the engine of the vehicle. The legs 42 may be made adjustable through having feet with threaded posts 54 which vary the length of the legs 42. Alternatively, a portion of the legs 42 may be interchangeable so that leg portions of different sizes or lengths may be used to adjust the height of the conduit 40.

It will be appreciated that the inventions are susceptible to modification, variation and change without departing from the spirit thereof.

1. A vehicle engine heater comprising:
a heater portion to generate a warm airstream, said heater portion having an electric motor and a blade assembly coupled to said motor along a motor shaft oriented along a longitudinal axis, and
a heat distribution portion coupled to said heater portion to distribute the warm airstream from said heater portion, said heat distribution portion including an elongated conduit and a base coupled to said elongated conduit, said elongated conduit having a series of air openings through which the warm airstream may pass, said elongated conduit being aligned along said longitudinal axis of said motor shaft.

2. The vehicle engine heater of claim 1 wherein said series of air opening are positioned along a top surface of said elongated conduit.

3. The vehicle engine heater of claim 1 wherein said base is adjustable in height.

4. The vehicle engine heater of claim 1 wherein said base includes a pair of legs.

5. The vehicle engine heater of claim 4 wherein each leg includes a pair of feet.

6. The vehicle engine heater of claim 5 wherein said feet are adjustable in height.

7. The vehicle engine heater of claim 1 further comprising a controller for controlling the actuation of the said heater portion.

8. A vehicle engine heater comprising:
a housing;
an air fan mounted within said housing, said air fan having an electric motor and a blade assembly coupled to said motor along a motor shaft oriented along a longitudinal axis;
a heating element mounted within said housing;
an elongated tube coupled to said housing, said elongated tube having a plurality of air openings therethrough, said elongated tube being aligned along said longitudinal axis of said motor shaft, and
a base coupled to said elongated tube to maintain the position of said elongated tube upon a supporting surface,
whereby with the base supporting the elongated tube upon a supporting surface an airstream generated by the operation of the air fan passes past the heating element so as to warm the airstream which is then passed into the elongated tube wherein the airstream passes through the plurality of air openings along an extended length.

9. The vehicle engine heater of claim 8 wherein said series of air opening are positioned along a top surface of said elongated tube.

10. The vehicle engine heater of claim 8 wherein said base is adjustable in height.

11. The vehicle engine heater of claim 8 wherein said base includes a pair of legs.

12. The vehicle engine heater of claim 11 wherein each leg includes a pair of feet.

13. The vehicle engine heater of claim 12 wherein said feet are adjustable in height.

14. The vehicle engine heater of claim 8 further comprising a controller for controlling the actuation of the said air fan.

15. A vehicle engine heater comprising:
a heat generator having an electric motor and a blade assembly coupled to said motor along a motor shaft oriented along a longitudinal axis, and
an elongated conduit coupled to said heat generator, said elongated conduit having a central channel and a plurality of air opening extending from said central channel to ambience, said elongated conduit being aligned along said longitudinal axis of said motor shaft.

16. The vehicle engine heater of claim 15 wherein said plurality of air opening are positioned along a top surface of said elongated conduit.

17. The vehicle engine heater of claim 15 further comprising an adjustable height base coupled to said elongated conduit.

18. The vehicle engine heater of claim 15 wherein said base includes a pair of legs.

19. The vehicle engine heater of claim 18 wherein each leg includes a pair of feet.

20. The vehicle engine heater of claim 19 wherein said feet are adjustable in height.

21. The vehicle engine heater of claim 15 further comprising a controller for controlling the actuation of the said heat generator.

22. The vehicle engine heater of claim 15 wherein said elongated conduit is flexible.
